(19) United States
(12) Patent Application Publication
(10) Pub. No.: US 2004/0249813 A1
(43) Pub. Date: Dec. 9, 2004

(54) Open component alliance

(76) Inventors: Pradeep Kumar Singh, Bangalore (IN); Lakshminarayanan Balasubramaniam, Bangalore (IN)

Correspondence Address: KENYON & KENYON, ONE BROADWAY, NEW YORK, NY, 10004, US

(21) Appl. No.: 10/455,293

(22) Filed: Jun. 4, 2003

(51) Int. Cl. G06F 7/00

(52) U.S. Cl. 707/9

(57) ABSTRACT

A method and system for navigating among software components in a computing device. This navigation may occur during run time and/or development time. A first information relating to a first component is received. The first information is configured to access a functionality and/or a command from the first component. The second information relating to a second component is received. The second information is configured to access a functionality and/or a command from the second component. Based on the first and second information, the functionality and/or command of the first component is dynamically and/or automatically provided to the second component. The first and second components may be based at some higher level on a same component, thus forming an alliance.

### FIELD OF THE INVENTION

The present invention relates to the area of software. In particular, the present invention relates to a method and system for dynamic and/or automatic extensibility of services to views in various applications.

### SUMMARY OF THE INVENTION

Embodiments of the present invention provide for a method and/or system that is utilized during development time and/or run time.

Embodiments of the present invention provide for a method and/or system for dynamic and/or automatic extensibility of services to views in Integrated Development Environment (IDE) applications.

Embodiments of the present invention provide for a method and/or system wherein information specified at development time may be enhanced, modified and/or extended during run time.

Embodiments of the present invention provide for easy extensibility of components and event handlings (i.e., the reaction to the event) and/or provide for dynamic and/or automatic sharing of functionalities of components.

Embodiments of the present invention provide for essentially unlimited extendibility based on the powerful extension and command/event routing embodiments of the present invention, which can be used in numerous available applications. Such applications may include any application having a cross-hierarchical structure of components, e.g., webpage design, etc.

Embodiments of the present invention provide for great maintainability and uniformity across different user interface (UI) components. This is in part due-to the easy sharing of functionalities between components.

Embodiments of the present invention provide for a method and/or system for navigating in a computing device between two or more entities that are dependent from a common software component. This dependency from a common software component may provide an “alliance” between the entities and a basis through which commands and event handlings can be extended, among other things.

Embodiments of the present invention provide that objects, e.g., applications, plug-ins, business components, etc., depending upon a same underlying software or model object are “allied,” or rather, are associated by a common element. The objects themselves do not need to know anything about each other in order to allow navigation between them, provided there is a common underlying software object. In embodiments of the present invention, objects need not know anything about each other in order to share commands, functionalites, services, and event handlings. In such embodiments, the different objects may be dynamically or automatically benefitted with another object(s)'s commands, functionalities, services, and event handlings. And, objects based on a common underlying software object can invoke the commands, functionalities, services, and event handlings. Thus, embodiments of the present invention may provide uniform generic features, e.g., menu commands and drag-n-drop in all the views.

In embodiments of the present invention, all objects may benefit from each other via their relationship, or “alliance.” This alliance can be found on different levels. An alliance may be made at any object level. In a specific example, such object levels can include but are not limited to an application level, a plug-in level, a user interface level, a component level and a sub-component level.

Embodiments of the present invention provide that the functionalities of a plurality of objects, which may include visible or nonvisible functionalities, associated with one or more underlying software or model objects may be dynamically provided to and/or accessible by all or some of the components. In further embodiments, the accessibility by the objects of the other functionalities may be determined by routing mechanisms, filters, hierarchical placement, and/or other considerations.

In embodiments of the present invention, a component such as a business object may have various aspects: attributes (e.g., a name); association with other objects (e.g., objects from which it depends); and behavior of the business object (e.g., may contain code). An object is dimensioned and thus, has many different views. Each view may highlight a different dimension, or aspect. For example, the relations view may focus on showing the related objects of a business object; the document-outline view may focus on showing certain properties as name, address, etc.; and the code view may focus on showing associated code for the business object.

In embodiments of the present invention, the term component, as described above with respect to objects, may be visual or non-visual components. For example, suppose there is a component which provides a functionality to delete objects. In some embodiments there may be no visual representation of the delete function except a notation, e.g., in a context menu of a selected object (provided the object can be deleted). This example component may effect the deletion when the delete command is selected.

In embodiments of the present invention, the component may include a command and a functionality. The command, associated with the functionality, may be used to execute the functionality. For example, in a case of a designer view for business objects, the designer view may have an associated command such as business-object-designer-view to open and/or close the designer view.

In embodiments of the present invention, the components, or objects, may include any number of and types of filters to prevent some functionalities from being accessed by a component, regardless of hierarchical position of the component and/or software object. A filter may be active and/or inactive depending upon various considerations. For example, a filter may be in effect, or active, when the filter's associated component is active, or when a sub-component of the filter's associated component is active. In further embodiments, the filter may be inactive when the filter's component is inactive, or when a particular sub-component of the filter's component is inactive. In further embodiments, the filter may be active/inactive depending upon the activeness/inactiveness of a higher level component associated with the filter and/or its actual associated component. In further embodiments, the activeness of the filter may be caused to be inactive based on additional instructions in the framework of the underlying application.

Embodiments of the present invention also may use and/or be represented via a variety of available languages, including, e.g., eXtensible markup language (XML), Java, or by a variety of other code languages.

Embodiments of the present invention provide a generic interface that allows any kind of extension to be added to the views in an efficient manner. That is, the designers to the views do not need to provide a further interface to implement the generic interface. Thus, functionalities, or service(s), may be applicable and supplied to multiple components without devising additional interfaces to implement the functionalities, or service(s). In such a situation, time and resources are preserved.

Embodiments of the present invention provide that any component may participate, i.e., is “open” to participate, without any fixed prior relationship to another component based on the same underlying software object. Such sharing of functionalities is provided based on command and event routing. In further embodiments of the present invention, this routing can be prioritized. And, command and event routing can be fully extendible—that is, any component can put itself into the command routing hierarchy.

Further embodiments of the present invention provide that a client does not need to invoke a service because the service provides and handles the commands through which it can be invoked.

In embodiments of the present invention, an application may be built by assembling a hierarchy of loosely coupled components. A complex component is built using a set of loosely coupled sub-components. The major components, e.g., designer, object hierarchy and application, may be extended in a simple manner and without touching or disturbing existing components. A component can be extended at design time using a configuration or extended at run time.

In embodiments of the present invention, sharing of functionalities between components may be achieved via the underlying model object. Each component focuses on its own functionality. The component may get additional functionalities dynamically from other components in the hub or alliance to which it is associated, i.e., “plugged-in.” That is, functionality implemented by a first component can be dynamically visible from the context of other components in the alliance. For example, if a designer implements functionality such as delete, cut/copy/paste and drag-n-drop for an element on its surface, the architecture of the present invention may also dynamically make these functionality commands available on a document outline of the designer. The document outline may focus on displaying the object in the required form.

In further embodiments of the present invention, alliances may be seen associated in a hierarchical fashion. For example, a lower level alliance may obtain functionality from a higher level alliance. However, a higher level alliance may not necessarily obtain functionality from a lower level alliance. In further embodiments, some commands may be valid only within a designer and its sub-views, e.g., document outline view, but not outside the designer. In further embodiments, an object may have the ability to filter functionalities provided by other objects based on other criteria.

In embodiments of the present invention, the alliance level of components or objects implicitly can indicate their priority. For example, the name of the component may be arranged to indicate the priority to include an application name, a plug-in name, the object name and the functionality name. For example, two possible functions from two different components might have the respective names: app5.VersionServices.customer.delete and app5.BOCustomer.customerorder.delete. Thus, even though the basic function name may be identical, the entire name of the function properly identifies it and indicates its priority. Thus, if the BOCustomer plug-in were higher on the priority scale than the VersionServices plug-in, this can affect which function is handled. In further embodiments, it is possible that only the first priority function will be handled unless the system allows or indicates otherwise, i.e., may allow the other function to be processed or otherwise. In some embodiments, there may be a particular order determined by the hierarchical position of the component or object, e.g., with respect to the level of the application, plug-ins, user interface, etc. To break from the particular predetermined, e.g., by the framework, priority and override the default ordering, one may specify the the priority level, i.e., for example, order the priority manually. In some embodiments, by default, when a command is registered, nothing need be said regarding the command's priority because it is the location at which it is registered which automatically determines its priority. In a further embodiment, there may be two components and two command handlers regarding the same command. In this embodiment, the higher priority command handler will be executed first. Routing may depend upon routing hierarchy.

In embodiments of the present invention, a component or object may get functionality(ies) from the other component(s) or object(s) in its own alliance. That same component or object may obtain functionalities not only from the other components in its alliance, but also from components belonging to higher level alliances (e.g., alliances to which a parent/grandparent/etc. component(s) or object(s) belong). For example, all components are attached to a designer-view level alliance, i.e., designer-view, document-outline, etc. The components in the designer-view level alliance may get functionalities provided from the higher level alliances such as the plug-in and application level alliances.

In embodiments of the present invention, while a component or object may get functionality(ies) from other component(s) or object(s) in its own alliance, the component or object may not obtain functionalities from components belonging to lower level alliances (e.g., alliances to which a parent/child/sub-child component(s) or object(s) belong). In further embodiments, this is the case even if the components are all based on the same software object. For example, in the case of a designer-view level alliance, any functionality of a document-outline can only be shared at a designer level, and not to other designer-views. This may be because the other designer-views are registered at the application level alliance and the document-outline is only registered at the designer level.

In embodiments of the present invention, a service may also provide and handle commands through which it can be invoked. For example, if a component provides a designer, it may also provide a command to invoke the designer. These components are allowed opportunities to add the commands in the appropriate menu at the appropriate time. A non-user interface component can also provide and handle menu commands or provide other functionalities such as drag-n-drop.

In embodiments of the present invention, with respect to events and event handlers, an event may give a specific signature, and be effective at only one component level, i.e., the level of the component providing the event. Thus, no hierarchy may be apparent. Embodiments of the present invention thus may extend the behavior of the event handler providing that event routing can be thus effected at the component level, the plug-in level, the application level, or any other component level.

In embodiments of the present invention, there may be a unifying of a common command and event behavior. That is, embodiments of the present invention may unify a generic common behavior. Type-safe command routing may be based on a routing part of a command and type-safe parts from events. In embodiments of the present invention, events may be routed as commands. That is, in combining an event and a command, the resulting entity may be referred to as a command. In further embodiments, command routing may allow any command (or event) to be handled by any component (and their alliance components) at any level in the current selection context. Type-safety can prevent error in the code and can facilitate more smooth development.

### BRIEF DESCRIPTION OF THE DRAWINGS

FIG. 1 shows a chart illustrating exemplary component hierarchy according to an embodiment of the present invention.

FIG. 2 shows a chart illustrating exemplary component hierarchy according to an embodiment of the present invention.

FIG. 3 shows an exemplary configuration file according to an embodiment of the present invention

FIG. 4 shows an exemplary screen view according to an embodiment of the present invention.

FIG. 5 shows an exemplary screen view according to an embodiment of the present invention.

FIG. 6 shows an exemplary screen view according to an embodiment of the present invention.

FIG. 7 shows an exemplary screen view according to an embodiment of the present invention.

FIG. 8 shows a chart illustrating an exemplary designer-manager according to an embodiment of the present invention.

FIG. 9 shows a sequence diagram including a service manager according to an embodiment of the present invention.

FIG. 10 shows a chart illustrating an exemplary command-service according to an embodiment of the present invention.

FIG. 11 shows a sequence diagram including command routing according to an embodiment of the present invention.

FIG. 12 shows a sequence diagram including command handlers according to an embodiment of the present invention.

FIG. 13 shows a sequence diagram including command routing according to an embodiment of the present invention.

FIG. 14 shows a sequence diagram including extensions according to an embodiment of the present invention.

### DETAILED DESCRIPTION

Embodiments of the present invention are directed to the visual interface in a software development environment.

Embodiments of the present invention are directed to dynamic navigation between different designer views of software object(s) defined for an application.

In particular, embodiments of the present invention may be used within the Mobile Application Studio system, and/or in conjunction with the embodiments discussed in U.S. application Ser. No. ______, “Cross-Platform Development And Runtime Environment For Mobile Devices And Companions,” filed on Jun. 4, 2003, the system information and other information discussed therein being incorporated in its entirety herein by reference.

In embodiments of the present invention, software objects may be similar to those, e.g., in the Model View Controller (MVC) architecture or SAP's Mobile Application Studio system (MAS). In embodiments involving SAP's Mobile Application Studio, the development environment may provide a metaframework for the development of business applications. The metaframework can allow a user to specify an application using a plurality of runtime objects referred to as business objects. Each business object functions as an abstract representation of a physical or logical entity providing a specific function within a business scenario. The development environment includes a corresponding business object (“BO”) modeling tool, which allows the developer to model BO properties, BO relations, business rules and queries. Generally, business objects may include data definitions, method, operational rules and constraints, access specifications, etc. that are particular to a specific business component, process, logical construct, etc. BO properties specify particular data items associated with a business object, BO relations control the interaction between business components at runtime and control data flow in a user interface layer, business rules specify logical operations executed by business objects and queries specify how interaction is to be conducted with an application database on the mobile device.

In further embodiments, the development environment further may include an interaction component modeling tool that allows a user to specify one or more user interface entities referred to as tiles. Data binding between business objects and tiles may be achieved through a GUI that allows a user to drag and drop business objects to particular tiles. The tiles may be logically grouped into tile sets.

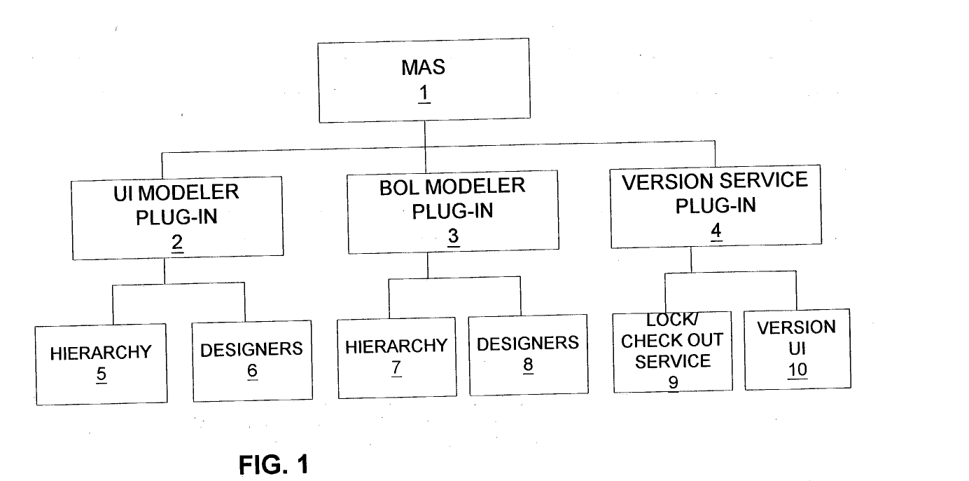

FIG. 1 shows a simplified component hierarchy view of an embodiment of the present invention. Specifically, FIG. 1 shows a system 1 as including a user interface (UI) modeler plug-in 2 having hierarchy 5 and designers 6; a business object logic (BOL) modeler plug-in 3 having hierarchy 7 and designers 8; and a version services plug-in 4 having a lock/check out service 9 and a user interface version 10. A plug-in can be a high-level component which groups related components, including, e.g., hierarchy, designers, lock/check out service and version UI. The UI modeler plug-in 2, BOL modeler plug-in 3 and the version services plug-in 4 are part of the application level alliance. Thus, the plug-in level services from all the plug-ins are shared, according to the present invention.

For example, in the SAP Mobile Application Studio system and other related systems, a software object, or model object, may include a designer view, a code view, a relation view, a document outline view (i.e., document outlines for the respective views), a version tree view, and a change list view. These views may be independent from each other. However, a user needs to navigate from one view to another view. In embodiments of the present invention, this navigation may be dynamically effected without additional coding the required information into objects with these views, or components. The command(s) to open or close different view(s) may be dynamically, or automatically, available in the object browser and change list, without any special coding. Such provision can allow a user to have uniform functionality across views without duplicating the implementation efforts for these views. For example, consider a screen designer which allows positioning of controls and modification of properties of the controls. The screen designer may support in a first view commands such as delete, cut/copy/paste and drag-n-drop of table fields on a control. If a document outline view, displaying controls in a hierarchical form, is created later for the screen designer, then all of the commands, as well as functionalities, shown in the first view are included in the document outline view, according to embodiments of the present invention. And, no duplication of implementation of the functionalities, such as refactoring or sharing some amount of code, may be required in the document outline.

In embodiments of the present invention, the object browser, e.g., a project tree-list, may be configured as a list of different projects in the workspace and the files inside each of the projects.

In some embodiments of the present invention, objects are versioned so every object needs to be checked out before any modification is made to the object. Thus, a change list component may be provided which may display all checked out objects.

Further embodiments of the present invention provide configuring the services for the different views of the software object based on user-role and solution. That is, e.g., a service which transfers the ownership of an object. Such service needs to be available in the administration (“Admin”) configuration only. Thus, according to embodiments of the present invention, such service can be “plugged-in” based on the configuration, so that the components from which this service is invoked are not modified.

Further embodiments of the present invention provide that any addition of a new functionality, or service, to any existing functionality does not affect the other. That is, e.g., a new designer view may be added without modifying any already-existing components. Or, e.g., a drag-n-drop support may be added to a designer view without modifying the existing functionalities in the designer view.

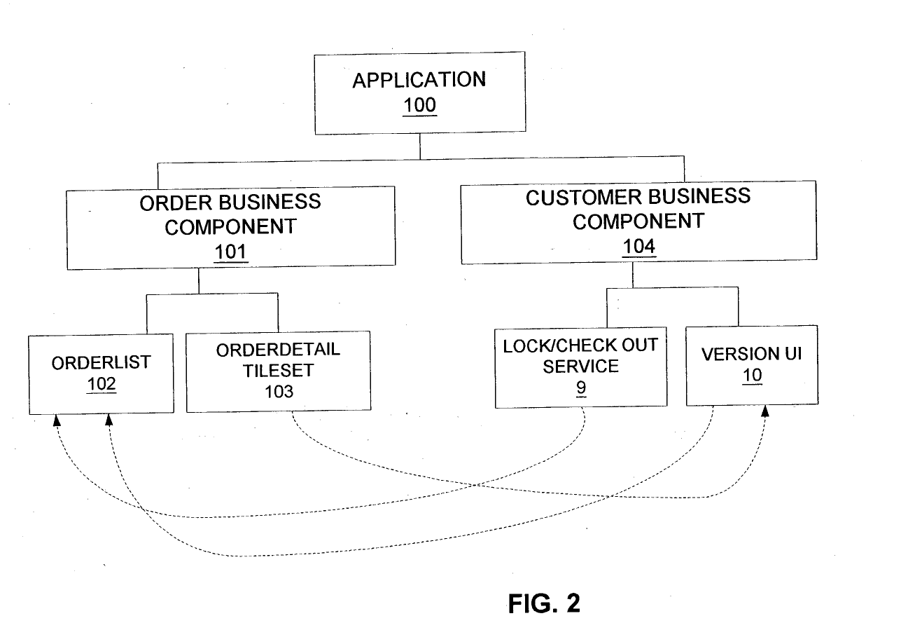

In FIG. 2, another embodiment of the present invention is illustrated. FIG. 2 shows another view of a simplified component hierarchy applicable to embodiments of the present invention. Application 100 is the top-level object of the component hierarchy. The application 100 contains one or more business components, corresponding to business building blocks. In FIG. 2, order business component 101 and customer business component 104 are shown. The business components, or building blocks, may need to share functionalities, and thus, there would be a need to navigate between tilesets. The tilesets of the order business component 101 shown include an orderlist tileset 102 and an orderdetail tileset 103. The tilesets of the customer business component 104 shown include a customer tileset 105 and a customer detail tileset 106. Thus, via embodiments of the present invention, one may navigate to the customer detail 106 from the order detail 103, and from the customer 105 to the order list 102. To effect and implement such navigation, conventional methods can require extensive additional coding and can require that the business components know each other in much detail. Instead, using the embodiments of the present invention, such extensive additional coding is not required. Further, the business components of order business 101 and customer business 104 do not need to have knowledge of each other. In fact, according to embodiments of the present invention, both business components could be completely independent, e.g., each being a part of a different plug-in, and the navigation between the tilesets of the business components could still be provided automatically. In this situation of different plug-ins, the alliance, as described herein, may be at the application level.

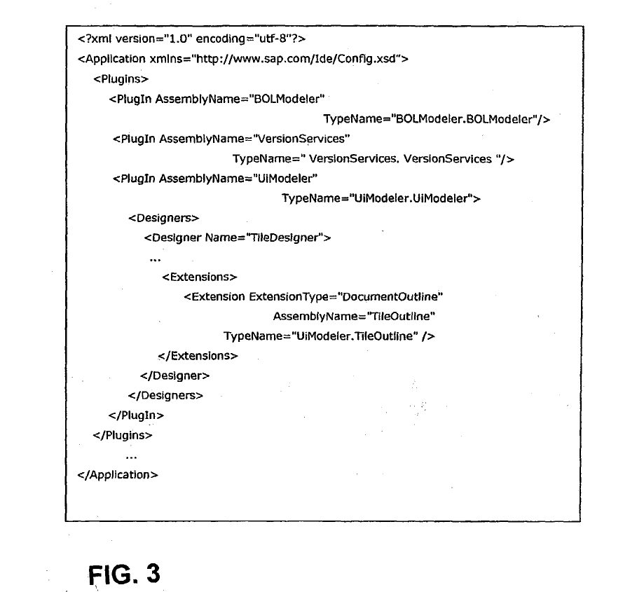

In FIG. 3, another embodiment of the present invention is illustrated. FIG. 3 shows an exemplary configuration file that may indicate the component hierarchy in an application. This configuration is in XML code; however, the configuration file could be written in any number of available languages.

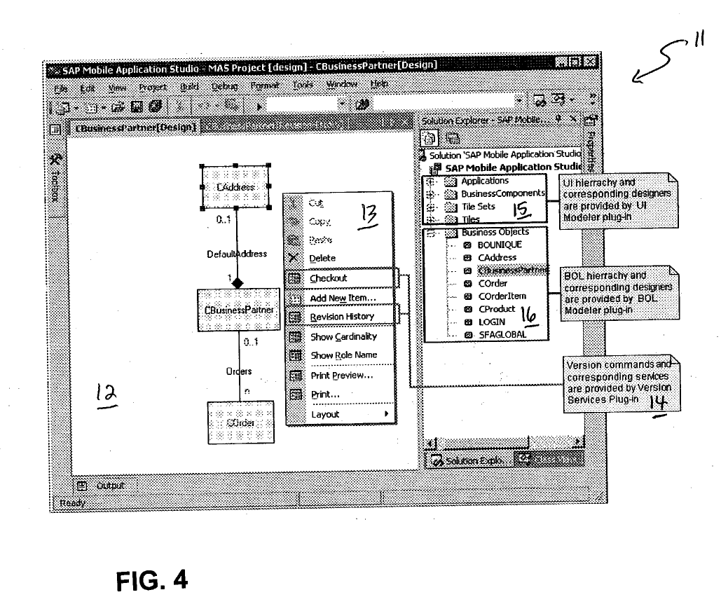

In FIG. 4, another embodiment of the present invention is illustrated. FIG. 4 shows a screen designer view 11 of some exem plary user interface elements provided by at least one of the UI Modeler plug-in 2, the BOL Modeler plug-in 3 and the Version Services plug-in 4. In the larger screen view 12, the designer view i for model objectCBusiness Partner, a part of the BOL Modeler plug-in. Version commands and corresponding services (here, checkout and revision history) 14 are shown listed in the list of BOL Modeler commands and corresponding services 13. The UI hierarchy and corresponding designer views 15 provided by the UI Modeler plug-in are shown. The BOL hierarchy and corresponding designers 16 provided by the BOL Modeler plug-in also are shown.

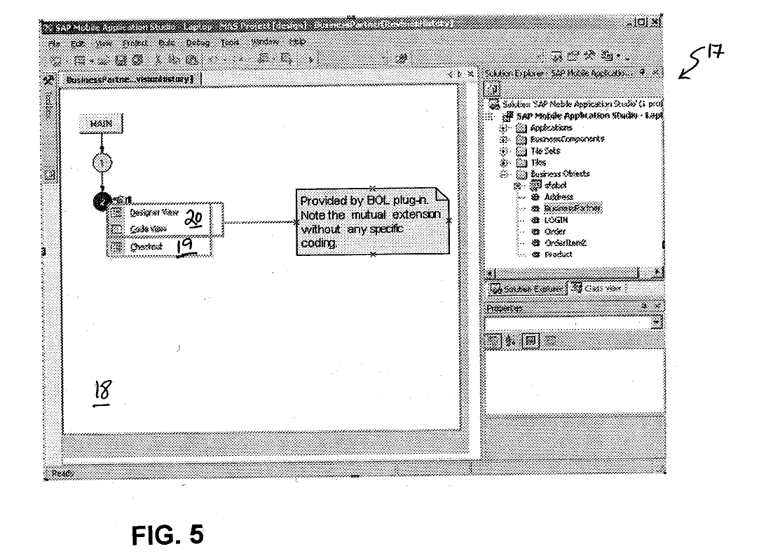

In FIG. 5, another embodiment of the present invention is illustrated. FIG. 5 shows a screen designer view 17 of some exemplary user interface elements provided by at least one plug-in. In the larger screen view 18, the designer view is BusinessPartner—versionhistory, a part of the Version Services plug-in. BOL Modeler commands and corresponding services (here, designer view and code view) 20 are shown listed in the list of Version Services Modeler commands and corresponding services 19. Both the functionalities—designer view and revision history—do not know each other directly here. Each designer view just provides its own commands through which it can be invoked. Commands to invoke a designer view in the client context may be dynamically provided because of the common software object. The designer view and the revision history functionalities should be open to accept such commands. In further embodiments of the present invention, the designer may be configured to filter outside commands.

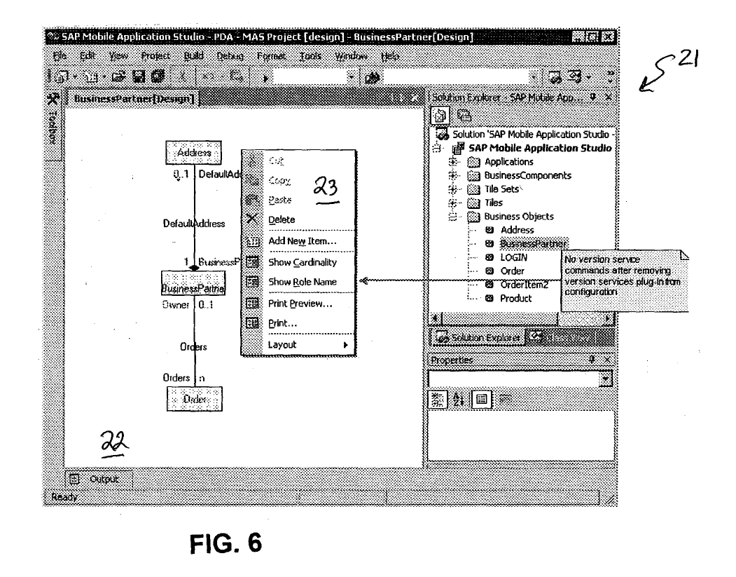

In FIG. 6, another embodiment of the present invention is illustrated. FIG. 6 shows a screen designer view 21 of some exemplary user interface elements provided by at least one plug-in. In the larger screen view 22, the designer view is BusinessPartner[Design], a part of the BOL Modeler plug-in. Specifically, the context menu 23 of the designer is illustrated after the Version Services plug-in is removed.

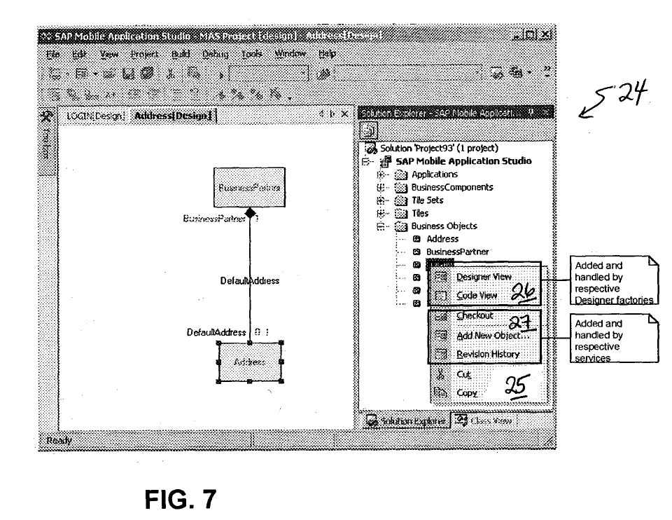

In FIG. 7, another embodiment of the present invention is illustrated. FIG. 7 shows a screen designer view 24 of some exemplary menu commands based on available designers. In FIG. 7, the commands—designer view, code view, checkout, add new object, revision history, etc.—in the context menu 25 of the object browser is provided based on the available designers and other services.

In further embodiments of the present invention, each major element, e.g., a designer, an object hierarchy, a plug-in and an application, is extendable. Extensions may be created via software code in the embodiments described herein. Further, for example, an extension may be created in a configuration file or program, e.g., an XML configuration file or program. When an application is loaded, all the plug-ins specified in a configuration file are loaded. The configuration file may contain enough information to load a component-like assembly name and type. Extensions for a designer may be created when the designer is loaded.

Further, once an extension is loaded, the extension may register its services to the service pools of extended components. For example, when a Business-Object-Logic Modeler plug-in is loaded, it registers its designer factory for the business-object designer view to the service pool of the application. See the designer-view illustrated in FIGS. 4, 5 and 6. The designer factory loads the designer 26 when required. The designer factory may be registered to a specific service called the design manager which manages the designer's pool. The designer manager may also take care of opening the editor—perhaps based on a command selected by a developer.

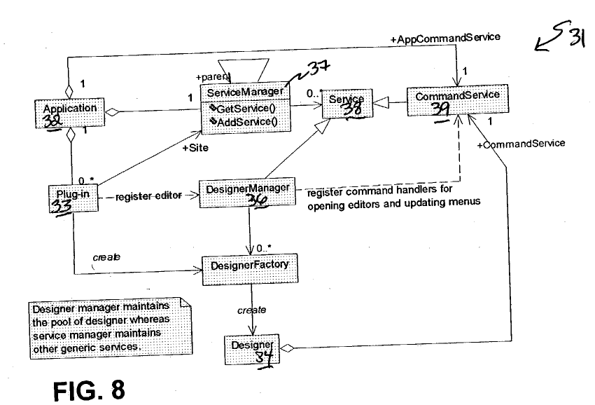

In FIG. 8, another embodiment of the present invention is illustrated. FIG. 8 shows a simplified high-level class hierarchy 31 in the application (i.e., not all associations may be shown). The application 32 is associated with the command service 39 and the plug-in 33. The plug-in 33 creates the designer factory 35. The designer factory 35 creates the designer 34 and is provided to the command service 39. The plug-in 33 also registers designers to the designer manager 36. Designer manager 36 maintains the pool of designer services. Further, the designer manager 36 registers command handlers for opening editors and updating menus. The plug-in 33 further communicates with the service manager 37. The service manager 37 maintains many generic services—not just designer services as maintained by the designer manager 36.

Command Service is a special type of service which can be used by the components for registering commands and explicitly triggering commands. CommandService can be available at different levels in the hierarchy.

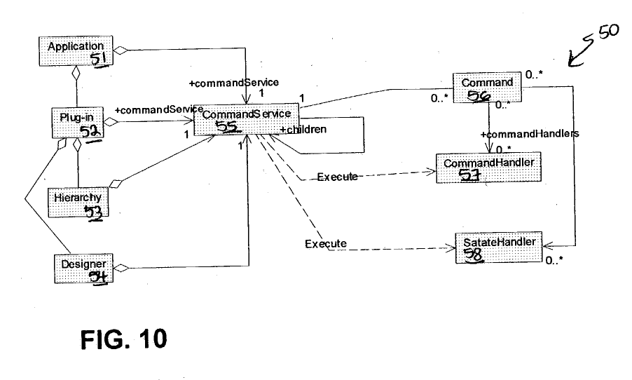

In embodiments of the present invention, a command service is owned by a component, e.g., designer, plug-in and application. More than one component can share the command service. For example, a document-outline-view can share the command service of the designer if the document outline works in the same context as the designer. When the designer becomes active, then its document outline is also activated or opened. Command handlers are registered to a Command Service object. See, e.g., FIG. 10 for an example diagram.

In embodiments of the present invention, the application framework routes a command to a command service based on its defined route and current selection context. For example, the routing may be in the reverse direction of the component hierarchy. That is, e.g., if a designer is active, first the command service of the designer gets a command to handle. Then the command service of the plug-in (parent of the designer) gets the command to handle, and then the command service of the application gets the command to handle. Thus, it can sometimes appear that the command services also form the hierarchy. Once a command service gets the command, it executes all command handlers attached to it, the command handler being the code that executes the functionality of a command.

Some embodiments of the present invention may provide that if the command is handled at a lower level, e.g., designer level, then the command will not go to the plug-in or the application level. However, a designer level command handler may be provided to allow the command to propagate to a higher level. Further, it can be provided that all command handlers in the same command service always get the chance to handle the command.

In further embodiments of the present invention, it may be arranged that command handlers at a higher level of the hierarchy, e.g., plug-in or application level, may apply to the component at a lower level of the hierarchy, e.g., a designer, but not vice-versa. That is a command handler at a lower level, e.g., designer, may only apply to the designer and its sub-components, but not for higher level components, e.g., plug-in.

Further embodiments of the present invention may include a priority mechanism. This priority mechanism can be used to change an exemplary standard routing procedure in which all command handlers always have the opportunity to execute a command within a single command service instance.

There are many types of priority for routing commands. One exemplary type is that which works within a single command service instance. This exemplary priority mechanism may change command routing, i.e., the command handling sequence, within a single command-service-instance. This mechanism may allow a command handler with higher priority to have the first opportunity to handle the command and potentially stop the propagation to the other command handlers.

In some embodiments of the present invention, there is no priority attached to the view—if more than one view, e.g., a designer or a document outline, share the same command service instance, then the command routing may be based solely on the priority of any command handlers in the command service. For example, if a designer view registers a drag-n-drop command handler with higher priority, then only that drag-n-drop command handler will be executed for all views accepting the drag-n-drop command attached with the command service. The command handler with lower priority will not be executed unless allowed by a command handler with a higher priority.

Another exemplary type of priority mechanism is that which works across command services in the same command service routing hierarchy. This mechanism may provide for a higher level(in the hierarchy) component to override the behavior of a lower component. In alternative embodiments, the command may be routed to the lower active component first. Further, such priority levels can be either of fixed value, i.e., fixed by the framework, set by a user in development time, etc.

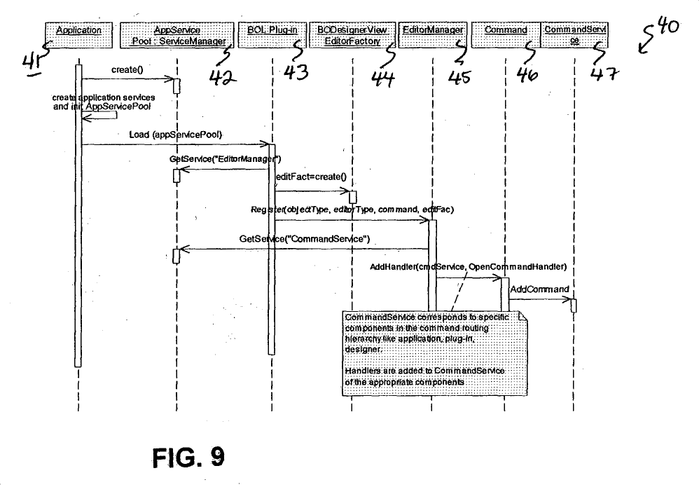

In FIG. 9, another embodiment of the present invention is illustrated. FIG. 9 shows the creation and registration 40 of BOL plug-in and its designers. The application 41 creates an AppServicePool managed by a created application services manager 42. The AppServicePool is loaded onto the BOL plug-in 43. The BOL plug-in 43 obtains services from the service manager 42 and creates the BOL designer view editor factory 44. The BOL plug-in 43 also registers with the editor manager 45. That is, the BOL plug-in 43 provides the required command to open the BOL designer view to the editor manager 45. The editor manager 45 passes the BOL designer view to the application command service 47 which creates the menu command. The command service corresponds to specific components in the command routing hierarchy, e.g., application, plug-in and designer.

In this embodiment, the model object type is passed by the BOL plug-in 43 while registering the command so that this command would be available and the specified command handler would be executed only if the model object attached to every selected object is of this type.

Similarly, in another embodiment, the command(s) to open the revision history, provided by the Version Services plug-in according to FIG. 4, is provided by the Version Services plug-in—not by the BOL Modeler plug-in. The revision history command should appear whenever the underling model object is of type business object.

In FIG. 10, another embodiment of the present invention is illustrated. FIG. 10 shows the main classes 50 in the command definition, routing and handling. As discussed above, the command architecture can provide for easy sharing of functionalities among components. In FIG. 10, application 51 is shown associated with a plug-in 52. The plug-in 52 is associated with its hierarchy 53 and provides a designer 54. The command service 55 gets the commands from the plug-in 52 and its hierarchy 53 and designer 54. The command service 55 maintains the command from the plug-in 52 and executes a command handler 57 and state handler 58.

A command object may correspond to a menu command, i.e., menu, toolbar or context menu commands, or any event, e.g., drag-n-drop, cut, copy paste, delete, etc. In the example of menu commands, commands have required information to create the menu commands in the user interface including, e.g., ID, text, icon, menu to attach, etc. Command classes in the command service 55 may provide methods to add and/or remove command handlers 57. For example, some command classes may be provided for specific commands where the command handler and other information(s) may differ.

Because command handlers are type-safe, as described earlier in this application, command classes may need to provide methods for registration.

Command handlers 57 may be function pointers that do the processing when a corresponding command 56 is executed, i.e., for example, the menu command is selected or an event is executed.

A command service can involve many roles. The command service can provide a way to create and update menu commands dynamically as well as execute any attached command handlers. The command service can also provide a mechanism so that only one command object is created for each command type. There is one command service 55 attached to each major component 54. And, any component 54 could have a command service 55 attached to it.

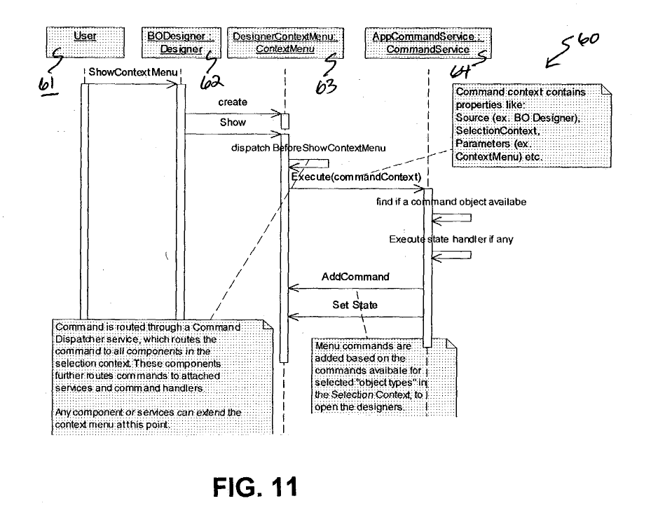

In FIG. 11, another embodiment of the present invention is illustrated. FIG. 11 shows a sequence diagram 60 for adding commands for version services and the designer view according to FIG. 4. Specifically, the user 61 provides a ShowContextMenu command to the BO Designer:designer 62. The BO Designer:designer 62 creates a DesignerContextMenu:contextmenu 63. The DesignerContextMenu:contextmenu 63 executes commandContext to the command service AppCommandService:commandservice 64. The commandContext may contain properties such as source (e.g. BO Designer), selectionContext, parameters (e.g., ContextMenu), etc Also, the DesignerContextMenu:contextmenu 63 routes the ShowContextMenu command through a command dispatcher service which then routes the command to all components in the selection context menu. These components further route commands to the attached services and command handlers. Thus, any component or service can extend the context menu at this point. The AppCommandService:commandservice 64 finds a command object if any and executes the state handler if any. The AppCommandService 64 then sets the state and sends an addcommand command to the DesignerContextMenu 63. The menu commands are added based on the commands available for selected object types in the SelectionContext to open the designers. For example, a command to open revision history and designer view were added for business objects.

Command services may keep the command information when the first command handlers are registered for a command. The actual menu (menu, toolbar and context menu) commands are created and updated based on the current selection context. The current selection of context menu consists of a current selected object and its parent/owner hierarchy. A command updation service asks command services of each object in a selection context to create and update the command. The command services create the available commands based on the command handlers attached to them. In addition, command services change the state, e.g., enable, disable or hide, of the commands based on the attached state handler, if any.

Among other times, commands to main menus may be updated in idle event. Unlike context menus, menu information for main menus may be taken from the command object itself. However, the main menu is added to, or updated, in the same manner as the context menu (as described herein).

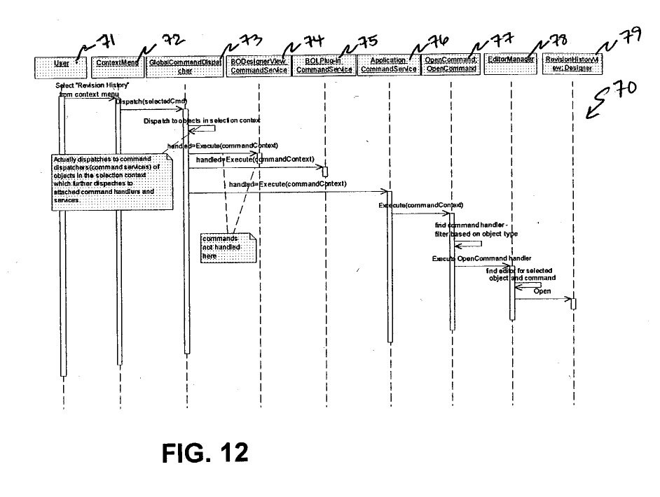

In FIG. 12, another embodiment according to the present invention is illustrated. FIG. 12 shows a sequence diagram 70 of how the “Revision History” is invoked from the “Designer View” of the business object. The “Designer View” is opened from “Revision History” in essentially the same manner as shown in earlier figures. Specifically, the user 71 selects ‘revision history’ from the contextmenu 72. The contextmenu 72 dispatches a selectedCommand to the global command dispatcher 73. The global command dispatcher 73 dispatches to objects in the selection context. The global command dispatcher 73 communicates the execute(commandContext) to the BO Designer view:commandservice 74 and to the BOL plug-in commandservice 75. The global command dispatcher 73 also communicates the execute(commandContext) to the application commandservice 76. The command is not handled by the BO Designer view:commandservice 74 or by the BOL plug-in commandservice 75. Instead, the command is handled by the Application commandservice 76. The Application commandservice communicates the execute(commandContext) to the opencommand:opencommand 77. The OpenCommand:opencommand 77 finds a command handler and filters the command based on the object type. The OpenCommand:opencommand 77 communicates an execute opencommand handler to the Editor manager 78. The Editor manager 78 finds the editor for the selected object and the corresponding command. The Editor manager 78 then opens the component resulting in the revision history view:designer 79.

Command routing is common in user interface applications. In the present invention, the event concept is also extended for routing. The event and command concept is combined to a large extent. Thus, events and commands can be handled at any level in the component hierarchy. This can allow dynamic or automatic sharing of functionalities among components at a higher level. That is, e.g., if a designer implements functionalities such as delete, cut/copy/paste, and/or drag-n-drop for an element on its surface, then these commands would be dynamically available on a document outline of the designer too. The document outline view would focus on displaying the object in the required form.

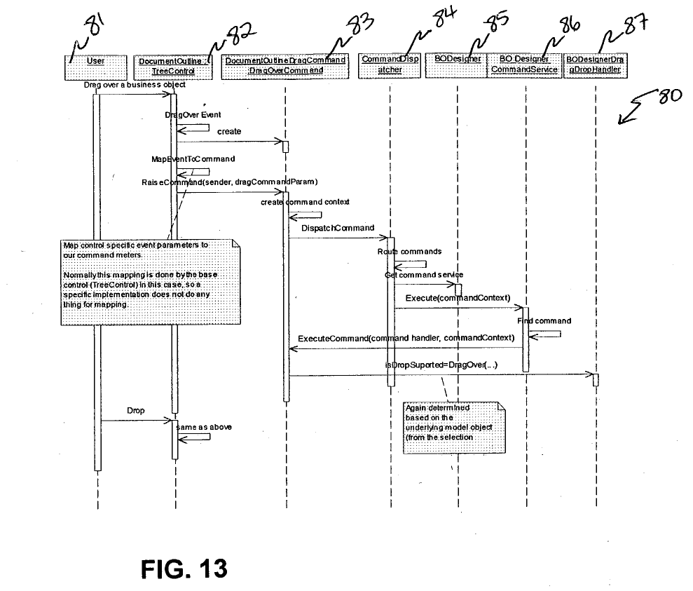

In FIG. 13, another embodiment according to the present invention is illustrated. FIG. 13 shows a sequence diagram 80 for a drag command on a document outline. Specifically, the user 81 drag-n-drops a business object to the document outline:tree control 82. The document outline:tree control 82 creates the dragovercommand in the document outline drag command 83. The document outline:tree control 82 communicates a raisecommand of the sender, drag command parameters to the document outline drag command 83. The document outline drag command 83 creates a command context and communicates a dispatch command to the command dispatcher 84. The document outline drag command 83 also communicates an isDropSupported command to the BO Designer Drag Drop Handler 87. The command dispatcher 84 routes the commands, communicates a get command service to the BO designer 85, and communicates an execute (command context) to the BO designer command service 86. The BO designer commandservice 86 maps the command to itself.

The document outline component does not implement the drag-n-drop feature. However, because the BO designer does allow implements, it dynamically gets the drag-n-drop feature. Note that throughout this application, “view” and “component” may be used interchangeably since some views may not be “visible” and instead be a function that is not necessarily visible. The document outline component does not implement the drag-n-drop feature because the BO designer 85 does implements, it gets the drag-n-drop feature dynamically.

It can be required that command handlers are executed in a particular sequence. For example, if a new wizard is added for drag-n-drop of a business object on BO designer view. If one doesn't want to touch the existing code written for drag-n-drop. If it is desired that the existing code written for drag-n-drop is not to be modified, one could just register a new command handler on a higher priority to invoke the new wizard before the earlier command handler. This priority mechanism can have the effect that the new drag-n-drop of the business object will be available to the other components lower on the priority list, without affecting their existing code.

The extensions extend the functionality by dynamically adding and handling commands. Extensions can also extend a component by providing implementation of one or more interfaces which may have been otherwise implemented by the component itself.

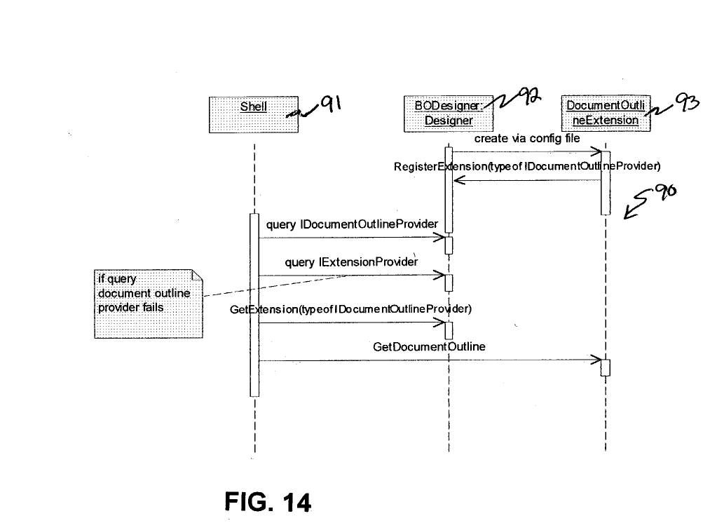

In FIG. 14, another embodiment according to the present invention is illustrated. FIG. 14 shows a sequence diagram 90 in which a designer implements an interface to provide a document outline. The application or shell 91 creates and manages the document outline frame for an active designer. The shell 91 requires the specific interface to be implemented by the designer. This interface returns the document outline control to be hosted in the document outline frame. Embodiments of the present invention may provide a method and/or system, in which the interface does not need to be implemented directly on the designer, but can be access via an extension. This allows the capability to not change a designer each time a new functionality in the application is available. In further embodiments, to support external extension types, extendable components may also provide an interface through which an extension can be queried by providing the type of extension desired. The interface may involve a method such as GetExtension (type extensionType), which returns the extension object. Through this interface, external components like the application 91 may get the document outline extensions. Specifically, in FIG. 14, the application or shell 91 queries the BO Designer:designer 92 re the idocument outline provider and, if that fails, the shell 91 queries the iextension provider. Further, the shell 91 requests the extension of the idocument outline provider from the BO Designer: designer 92 and eventually gets the document outline from the Document outline extension 93. The BO Designer:designer 92 creates the document outline extension 93 via a configuration file. The document outline extension 93 communicates a register extension to the BO Designer:designer. The register extension is an idocument outline provider type.

The embodiments described herein are not meant to be exhaustive or all-inclusive. Further, various combinations of the above embodiments are also possible according to the present invention.

What is claimed is:

1. A method for navigating among software components in a computing device, comprising:
receiving first information relating to a first component, the first information configured to access a functionality therein;
receiving second information relating to a second component, the second information configured to access a functionality therein;
based on the first and second information, dynamically providing the functionality of the first component to the second component.

2. The method of claim 1 wherein the first and second components are based on the same underlying component.

3. The method of claim 2 further comprising:
accessing the functionality of the first component by the second component, the coding of the second component remaining relatively intact.

4. The method of claim 3 wherein there is uniform functionality across a plurality of views of at least one of the first component and the second component.

5. The method of claim 4 wherein the functionality is at least one of delete, drag-n-drop, cut, copy, paste, check-in, check-out, print, print preview, layout, add new item, show cardinality, show role name, revision history, designer view, and code view.

6. The method of claim 4, wherein the plurality of views includes at least one of a designer view, a relation view, a document outline view, and a code view.

7. The method of claim 1, wherein the first component stems from a first software object and the second component stems from a second software object, and the first software object and the second software object both stem from a third software object.

8. The method of claim 3 further comprising providing a filter to the second component, the filter being configured to prevent access to the first functionality so that the second component prevents any access to the first functionality.

9. The method of claim 1 wherein:
a) if the first component belongs to the same level alliance as the second component, then the second component may get the functionality from the first component;
b) if the first component belongs to a higher level alliance than the second component, then the second component may get the functionality from the first component; and
c) if the first component belongs to a lower level alliance than the second component, then the second component is prevented from getting the functionality from the first component.

10. The method of claim 9 wherein an alliance is established by a common component level between the first and second components.

11. A method for navigating among software components, comprising:
receiving a first information relating to a first component, the first information configured to access a functionality;
receiving a second information relating to a second component, the second information configured to access a functionality;
as a function of the first information and the second information, automatically providing the functionality of the first component to the second component.

12. The method of claim 11 wherein the first and second components are based on the same underlying component.

13. The method of claim 11 further comprising:
accessing the first functionality by the second component without involving manual coding in the second component.

14. The method of claim 11, wherein the first component and the second component are the same software object.

15. A system for navigating in a computing device, comprising:
a first component, the first component associated with a first information configured to access a functionality; and
a second component, the second component associated with a second information configured to access a second functionality;
based on the first and second information, dynamically providing the functionality of the first component to the second component.

16. The system of claim 15 wherein the first and second components are based on the same underlying component.

17. The system of claim 16 wherein the first component is a first software object and the second component is a second software object.

18. The system of claim 16 wherein the functionality of the first component is accessed by the second component and the coding of the second component remains intact.

19. The system of claim 16 wherein the second component includes a filter which prevents access by the second component to the first functionality.

20. The system of claim 16 wherein there is uniform functionality across a plurality of views of the first component and the second component.

21. The system of claim 16 wherein the first functionality is at least one of delete, drag-n-drop, cut, copy, paste, check-in, check-out, print, print preview, layout, add new item, show cardinality, show role name, revision history, designer view, and code view.

22. The system of claim 20, wherein the plurality of views includes at least one of a designer view, a relation view, a document outline view, and a code view.

23. A system for extending functionalities in a software environment, comprising:
a computing device including a program architecture utilizing at least a first component and a second component;
a first information associated with the first component, the first information including a first command and a first functionality; and
a second information associated with the second component, the second information including a second command and a second functionality;
based on the first and second information, automatically providing the first functionality and the first command to the second component, wherein the first functionality and the first command are accessible by the second component when the second component is active, and as a function of the first information and the second information a type-safe command routing is effected.
